(19) United States
(12) Patent Application Publication
(10) Pub. No.: US 2006/0103802 A1
(43) Pub. Date: May 18, 2006

(54) Liquid crystal display device sealed with liquid crystal seal composed of anisotropic conductive material

(76) Inventors: Yasuhiro Miki, Fukushima-ken (JP); Manabu Kusano, Fukushima-ken (JP); Zennosuke Mitani, Fukushima-ken (JP); Takahito Mafune, Fukushima-ken (JP)

Correspondence Address: BRINKS HOFER GILSON & LIONE, P.O. BOX 10395, CHICAGO, IL, 60610, US

(21) Appl. No.: 11/270,238

(22) Filed: Nov. 8, 2005

Related U.S. Application Data
(62) Division of application No. 10/463,147, filed on Jun. 16, 2003.

(30) Foreign Application Priority Data
Jun. 17, 2002 (JP) 2002-175768
Jun. 17, 2002 (JP) 2002-175788

(51) Int. Cl. G02F 1/1339

(52) U.S. Cl. 349/153

(57) ABSTRACT

The particle diameter of a conductive particle is set to one-third of an interval between adjacent terminals or below and 1 μm or greater in groups of terminals. The conductive particle has a conductive layer covered with an insulating film. In the portions where the conductive particle is contacted with the terminals facing each other, the insulating film is removed to contact the conductive layer with the terminals.

### PRIORITY CLAIM

The present application is a divisional of U.S. patent application Ser. No. 10/463,147 filed Jun. 16, 2003, which claims under 35 U.S.C. § 119 the benefit of the filing date of Japanese Patent Applications Nos. 2002-175768 and 2002-175788, filed Jun. 17, 2002, each of which is incorporated herein in its entirety by this reference.

### BACKGROUND OF THE INVENTION

1. Field of the Invention

The present invention relates to a liquid crystal display device, particularly to a liquid crystal display device using an anisotropic conductive material for interconnection between terminals facing each other and capable of obtaining stable electrical characteristics.

2. Description of the Related Art

For display parts of video devices, personal computers, and personal digital assistants, liquid crystal display devices are often used. In the liquid crystal display devices, conductive rubber connectors and film connectors have traditionally often been used as a unit for connecting a plurality of terminals on the cell side arranged side by side at fine space in the peripheral part of liquid crystal substrates to terminals on the driver side facing thereto one to one. In recent years, in order to meet a demand of forming the liquid crystal display part in higher definition, contradictory demands of forming a large screen while reductions in size and thickness, or demands of the realization of more efficient fabrication work and cost reductions, as a unit for connecting the terminals, techniques have rapidly become widespread such as COG (Chip On Glass) and TCP (Tape Carrier Package). In the TCP technique an FPC (Flexible Print Circuit) having driver ICs mounted on a tape carrier is connected to the terminals. It has also been required to reduce the liquid crystal display part, from demands such as the reduction of devices in size, enhance the space efficiency, reduce_the number of driver IC components, streamline mounting work, and reduce the cost. To this end a system has begun to be adopted that circuit terminals of two liquid crystal substrates are gathered on only one of the two liquid crystal substrates. In this case, a technique is required that directly connects terminals that face each other, the terminals being disposed on the two liquid crystal substrates except in a predetermined gap formed by a liquid crystal seal that seals a liquid crystal layer sandwiched between the substrates. An anisotropic conductive material is often used as a unit for collectively and vertically connecting the plurality of the terminals, which are arranged side by side at a fine fine spacing while the adjacent terminals maintain highly reliable insulation.

FIG. 14 schematically illustrates the configuration of a terminal connecting part with a traditional anisotropic conductive material. In FIG. 14, two overlaid substrates 101 and 102 are formed with terminals 103 . . . and 104 . . . , respectively, at positions facing each other on the inner sides. The adjacent terminals on each of the substrates are spaced at terminal interval Ws so as not to be contacted with each other. The terminal interval Ws is about a half of terminal pitch P. An anisotropic conductive layer 105 is interposed between the two substrates 101 and 102. In the anisotropic conductive layer 105, conductive particles 107 . . . are dispersed in an adhesive resin base material 106 in appropriate ratio. When the anisotropic conductive layer 105 is pressed from above and below in a state that it is sandwiched by the two substrates 101 and 102, a conductive particle 107a . . . sandwiched between the terminals 103 and 104 facing each other among the conductive particles 107 . . . is pressed by the upper and lower terminals, and then the terminals 103 and 104 facing each other are electrically connected. At this time, no matter whether the conductive particle 107a is compressed by the upper and lower terminals and deformed flat to some extent as shown in FIG. 14 or whether the conductive particle presses the contact surfaces of the terminals and a part thereof enters the terminal surfaces, the contact areas of the conductive particle with the terminals increases. Consequently, substantial conductivity is achieved. In the meantime, conductive particles 107b dispersed in the terminal interval Ws are neither contacted with each other nor with the terminals, thus being electrically isolated. More specifically, the anisotropic conductive layer 105 is conductive in the direction of the terminals facing each other (in the vertical direction) when sandwiched and pressed by conductors, but it is nonconductive in the direction of the adjacent terminals (in the horizontal direction). The technique is simple and highly reliable as the unit for directly and collectively connecting the plurality of the terminals each other arranged at fine space, being widely used for connecting various terminals in the liquid crystal display device.

For example, in Japanese Unexamined Published Patent Application No. H1-237520, an anisotropic conductive layer is used for connecting power supply terminals on liquid crystal substrates to an FPC mounted with driver ICs. Japanese Unexamined Published Patent Application No. H5-249483 proposes the use of an anisotropic conductive material in which conductive particles are mixed with nonconductive spacers in order to prevent deficiency such as interconnection failure between terminals from being generated, which is caused by variations in the particle diameter of the conductive particles or variations in conditions in pressing, and in performing so-called common transfer in which electrode wiring is transferred from one of vertically overlaid liquid crystal substrates to the other. Furthermore, International Publication WO 99/52011 proposes the use of an anisotropic conductive material containing conductive particles as a part of a liquid crystal seal disposed around a liquid crystal layer in performing the common transfer.

However, further advances are needed for a colored, high definition/large liquid crystal display screen, and an enormously large number of circuit terminals have to be arranged in a limited space. Consequently, terminals inevitably need to be arranged at fine pitch. A terminal width denoted by sign Wt and the interval between the adjacent terminals denoted by sign Ws shown in FIG. 14 must be significantly reduced. Accordingly, many problems have arisen in the traditional anisotropic conductive material. More specifically, as seen in the recent high-definition color liquid crystal display device, when the terminal pitch denoted by sign P shown in FIG. 14 is shortened to about 10 to 50 μm, slight unevenness in a dispersed state of the conductive particles 107 in the anisotropic conductive layer 105 causes the number of the conductive particles 107 sandwiched between the upper and lower terminals for supporting conductivity to be greatly varied between the adjacent terminals as schematically shown in State A in FIG. 15, and variations are generated in conductive resistance between the upper and lower terminals 103 and 104. Sometimes, the conductive particles are not substantially disposed between the upper and lower terminals to cause nonconductivity or high resistance as shown in State B. As shown in State C, conductive particles protruded from between the terminal ends substantially narrow the terminal interval Ws as denoted by sign Wr, and electric resistance and capacitance between the adjacent terminals are varied. Sometimes, the conductive particles are linked in a chain to cause a short circuit between the adjacent terminals as shown in State D. Particularly in a color matrix liquid crystal display part of multi-gray scale, a drive waveform with significantly high frequency components is applied to pixel electrodes. Thus, slight changes in conductivity between the upper and lower terminals and in insulation resistance and capacitance between the adjacent terminals cause the operation of the liquid crystal display device to be unstable, and the device is turned to be a defective item, being a cause to decrease fabrication yields. When the anisotropic conductive layer 105 is used as a liquid crystal seal, conductive particles 107c also serving as spacers of a liquid crystal are expanded or contracted in response to a change in ambient temperature as shown in State E in FIG. 15, for example, and then gap G of a liquid crystal layer 108 is increased or decreased to cause the operation of the liquid crystal display part to be unstable in any cases.

### SUMMARY OF THE INVENTION

The invention has been made to solve the problems. Therefore, an object thereof is to provide a liquid crystal display device capable of obtaining stable interconnection between terminals with the use of an anisotropic conductive material even though the terminals are arranged at a fine pitch.

In order to solve the problems, the invention is to provide a liquid crystal display device having groups of terminals connected to each other, the groups of the terminals facing each other through an anisotropic conductive layer having a conductive particle dispersed in a resin, wherein a particle diameter of the conductive particle is one-third of an interval between the adjacent terminals or below and 1 μm or greater.

When the particle diameter of the conductive particle is set to one-third of the interval between the adjacent terminals or below, the number of the conductive particles supporting conductivity as sandwiched between the terminals facing each other is not varied in a great ratio even though the dispersed state of the conductive particles is uneven to some extent. Therefore, the variations in conductive resistance between the terminals facing each other are small. The probability that the conductive particles are protruded from between the terminals to substantially narrow the interval between the adjacent terminals, causing electric resistance and capacitance to be varied, or that the terminals adjacent in a chain are short-circuited is greatly reduced. Furthermore, the probability that the gap is varied by temperature change to cause the operation of the liquid crystal display part to be unstable when the anisotropic conductive layer is used as the spacer of the liquid crystal display part is also minimized. However, when the particle diameter of the conductive particle is below 1 μm, recesses are generated by surface roughness of the terminals, or the conductive particles press the terminal surface to be depressed, which cause the conductive particles to be buried in the terminal surface to lose the connection function. It also becomes difficult to fabricate the particle itself. Therefore, the substantial advantage of the anisotropic conductive layer is lost.

In order to solve the problems, the invention is to provide a liquid crystal display device having groups of terminals connected to each other, the groups of the terminals facing each other through an anisotropic conductive layer having a conductive particle dispersed in a resin, wherein the conductive particle has a conductive layer covered with an insulating film, and the insulating film is removed in a portion contacted with the terminals to contact the conductive layer with the terminals. Here, the conductive particle is preferably pressed and deformed in a state that the conductive particle is sandwiched between the terminals.

When the conductive particle has the conductive layer covered with the insulating film and the insulating film is removed in the portion where the conductive particle is contacted with the terminals, the exposed conductive layer is directly contacted with the both terminals and the both terminals are conducted through the conductive particle. When the conductive particle is pressed and deformed flat in a state that the conductive particle is sandwiched between the terminals facing each other in the fabrication of the liquid crystal display part, the insulating film in the portion contacted with the terminal surface is peeled and removed in a wider area. Consequently, the contact areas of the terminals with the conductive layer are increased to reduce electric resistance between the terminals through the conductive particle. On the other hand, the conductive particles dispersed in the interval between the adjacent terminals are not sandwiched between the terminals facing each other. Thus, pressure applied thereto is small, and the insulating film is not peeled. Therefore, they are nonconductive even though they are contacted with the other conductive particles. Accordingly, even though the pitch between the terminals is reduced to about 10 to 50 μm, for example, in high-density mounting, or the dispersed state of the conductive particles is uneven in the anisotropic conductive layer to cause the conductive particles to be linked to each other, there is no probability that the electric resistance and capacitance between the adjacent terminals are varied or that the adjacent terminals are short-circuited based on these. Therefore, electric characteristics between the terminals become stable.

Preferably, the insulating film is made of a resin or metal oxide.

As examples of the resin used for the insulating film, organic silicon compounds can be named (for example, it is deposited by a sol-gel process based on a solution). As examples of the metal oxide, publicly known metal oxides can be named, including SiO₂, SiO₂—ZrO, and TiO₂ (for example, it is deposited by physical methods such as vapor deposition and sputtering), or metal oxide passivation films such as nickel oxides and chromium oxides. The film thickness of the insulating film is not particularly defined. However, in association with film strength, the insulating film needs to be broken and removed from the portion contacted with the terminals when the conductive particle is pressed and deformed flat between the terminals facing each other in the fabrication of the liquid crystal display part. Generally, the film thickness of the insulating film is preferably almost the same as the thickness of the terminals sandwiching the conductive particle. More specifically, when the terminals are made of ITO (Indium-Tin-Oxide) drawn from pixel electrodes, for example, the thickness is 0.2 to 0.3 μm. Therefore, the film thickness of the insulating film in this case is preferably in the range of around 0.5 to 0.6 μm.

The material of the conductive layer is not defined particularly when it is excellently conductive, and the thickness of the conductive layer is not defined particularly as well because only the surface needs to be conductive. When only the surface is formed to be conductive, such particles are acceptable as the surface of beads, such as resins and inorganic substances (SiO₂), undergoes electroless plating. As the materials for the conductive layer, chemically stable metals such as gold, tin, and palladium, or alloys such as nickel-gold and tin-lead solder (9:1) can be named.

Preferably, the conductive particle has a core material pressable and deformable.

The core material inside the conductive layer may be formed integrally with the conductive layer and formed of the same material as that of the conductive layer, or formed of a material different therefrom. When the core material is made of a material different from the conductive layer, the material may be conductive or nonconductive. In any case, the core material is preferably pressable and deformable.

Provided that the conductive particle has a core material deformable by pressing force when the conductive particle is pressed while being sandwiched between the terminals facing each other, the core material is deformed flat to peel and remove the insulating film in the portion contacted with the terminal surface in a wider area. Consequently, the contact areas of the terminals with the conductive layer are increased, and sufficient conductivity is secured between the both terminals through the conductive particle. Preferable core materials are those plastically deformable by pressure applied between the upper and lower terminals in assembling the liquid crystal display part, ranging within 0.3 to 1.0 kg/cm², for example; they may be conductive or nonconductive. As examples of the conductive core material, solder particles can be named. As examples of the nonconductive core material, spherical particles of divinylbenzene-based resins, styrene-based resins, phenol-based resins, or copolymers of these can be named.

Preferably, the mixing ratio of the conductive particle in the anisotropic conductive layer according to the invention is in a range of 0.5 to 3.5 percent by weight.

When the mixing ratio is in the range, a sufficient number of the conductive particles is dispersed between the upper and lower terminals facing each other to achieve practical conductivity. Particularly, the probability that the conductive particles are not dispersed between the upper and lower terminals to be nonconductive is almost eliminated. When the ratio of the conductive particles is below 0.5 percent by weight, it is not preferable because the average number of the particles to be dispersed between the upper and lower terminals is reduced, conductive resistance is increased, and the variations in conductive resistance are raised as well. When exceeding 3.5 percent by weight, it is not preferable because the viscosity of the anisotropic conductive material is increased to generate a void in the anisotropic conductive layer, or to cause the particles to tend to be linked, which decreases insulation resistance between the adjacent terminals, increases capacitance, and sometimes generates the probability to cause short circuits. In the conductive particle covered with the insulating film, when the particles rub each other to break the insulating film, it is not preferable because insulation resistance between the adjacent terminals is decreased, capacitance is increased, and the probability to generate short circuits is sometimes increased.

It is acceptable that the anisotropic conductive layer in the invention contains a nonconductive spacer. In this case, the particle diameter of the conductive particle (the particle diameter at the conductive layer in the conductive particle covered with the insulating film) is preferably greater than the cross-sectional diameter of the spacer in the range of 0.02 to 0.5 μm.

When the anisotropic conductive layer contains the nonconductive spacer, a fixed thickness corresponding to the particle diameter of the spacer is secured between the terminals in sandwiching and pressing the anisotropic conductive material between the upper and lower terminals. Thus, electric characteristics and temperature characteristics between the terminals become stable. Particularly, in performing common transfer in the liquid crystal display part, when the anisotropic conductive layer is used as at least a part of the liquid crystal seal disposed between two substrates facing each other which surround the liquid crystal layer, the spacer defines the gap between the two substrates. At this time, a material having less expansion and contraction caused by temperature change can be selected as the spacer. Therefore, a liquid crystal display part stably operated with less gap variation can be obtained. When the particle diameter of the conductive particle is formed greater than the particle diameter of the spacer in the range of 0.02 to 0.5 μm, either the case where the conductive particle is pressed flat within the gap width defined by the spacer or the case where the conductive particle enters in the terminal surface, or both cases increase the contact areas of the conductive particle with the terminals. Consequently, excellent conductivity is achieved. In the conductive particle covered with the insulating film, the conductive particle is pressed flat within the gap width defined by the spacer, the insulating film is peeled and removed in the surface contacted with the terminals, and the contact areas of the exposed conductive layer with the terminals are increased. Therefore, excellent conductivity can be secured.

When the difference between the particle diameters of the conductive particle and the cross-sectional diameter of the spacer is below 0.02 μm, the degree of the conductive particle to be deformed is low and the contact areas of the terminals with the conductive particle are sometimes not secured sufficiently. When it exceeds 0.5 μm, there is the probability that the conductive particle is greater than the particle diameter of the spacer even though it is pressed and the spacer cannot define the gap width.

In the liquid crystal display device in the invention, it is acceptable that one of the groups of the terminals facing each other is formed on a liquid crystal substrate and the other is formed on an external board. It is fine that the groups of the terminals facing each other are formed on the inner surfaces of liquid crystal substrates facing each other with a liquid crystal layer sandwiched.

More specifically, it is acceptable that one of the groups of the terminals facing each other is a group of terminals extending from pixel electrodes formed on the liquid crystal substrates of the liquid crystal display part, and the other is, for example, a group of terminals formed on an FPC mounted with driver ICs. In performing common transfer in the liquid crystal display part, the groups of the terminals facing each other are formed on the inner surfaces of the liquid crystal substrates facing each other with the liquid crystal layer sandwiched. The anisotropic conductive layer containing the spacers is preferably interposed between the groups of the terminals. Consequently, the anisotropic conductive layer also serves as the liquid crystal seal as conductivity between the groups of the terminals facing each other is secured.

In the liquid crystal display device in the invention, the particle diameter of the conductive particle in the anisotropic conductive layer sandwiched between the groups of the terminals facing each other is one-third of the interval between the adjacent terminals or below; and the conductive particle in the anisotropic conductive layer has the conductive layer covered with the insulating film and the insulating film is removed in the portion contacted with the terminals to contact the conductive layer with the terminals. Therefore, the resistance variation, capacitance variation, and short circuits are effectively suppressed between the adjacent terminals as stable conductivity is secured between the terminals facing each other. In addition to this, the gap variation in the liquid crystal layer caused by temperature change is also effectively suppressed in common transfer, the defect rate in fabrication is reduced, and a small-sized liquid crystal display device of high quality and high definition with stable operation can be obtained.

### BRIEF DESCRIPTION OF THE DRAWINGS

The teachings of the invention can be readily understood by considering the following detailed description in conjunction with the accompanying drawings, in which:

FIG. 1 is a plan view illustrating a liquid crystal display part in one embodiment of the invention;

FIG. 2 is an enlarged plan view illustrating portion P shown in FIG. 1;

FIG. 3 is a cross-sectional view of line 3-3 shown in FIG. 2;

FIG. 4 is a graph illustrating the relationship between the particle diameter of the conductive particle and the occurrence rate of variations in the gap;

FIG. 5 is a plan view illustrating a liquid crystal display part in another embodiment of the invention;

FIG. 6 is a cross-sectional view of line 6-6 shown in FIG. 5;

FIG. 7 is a graph illustrating the relationship between the particle diameter of the conductive particle and the occurrence rate of short circuits between the adjacent terminals;

FIG. 8 is a plan view illustrating a liquid crystal display part in still another embodiment of the invention;

FIG. 9 is an enlarged plan view illustrating portion P shown in FIG. 8;

FIG. 10 is a cross-sectional view of line 10-10 shown in FIG. 9;

FIG. 11 is a plan view illustrating a liquid crystal display part in yet another embodiment of the invention;

FIG. 12 a cross-sectional view of line 12-12 shown in FIG. 11;

FIG. 13 is a graph illustrating the relationship between the particle diameter of the conductive particle and the occurrence rate of short circuits between the adjacent terminals;

FIG. 14 is a cross-sectional view illustrating the configuration of the terminal connecting part using the traditional anisotropic conductive material; and

FIG. 15 is a cross-sectional view illustrating various states of conductive particles in the traditional anisotropic conductive layer.

### DESCRIPTION OF THE PREFERRED EMBODIMENT

Next, embodiments of the invention will be described by specific examples, but these specific examples will not limit the invention. The accompanying drawings are for describing the teachings of the invention in which unnecessary components for describing the invention are omitted and the shapes, dimensions, and numbers of each of the components in the drawings are not necessarily matched with the actual ones.

### Embodiment 1

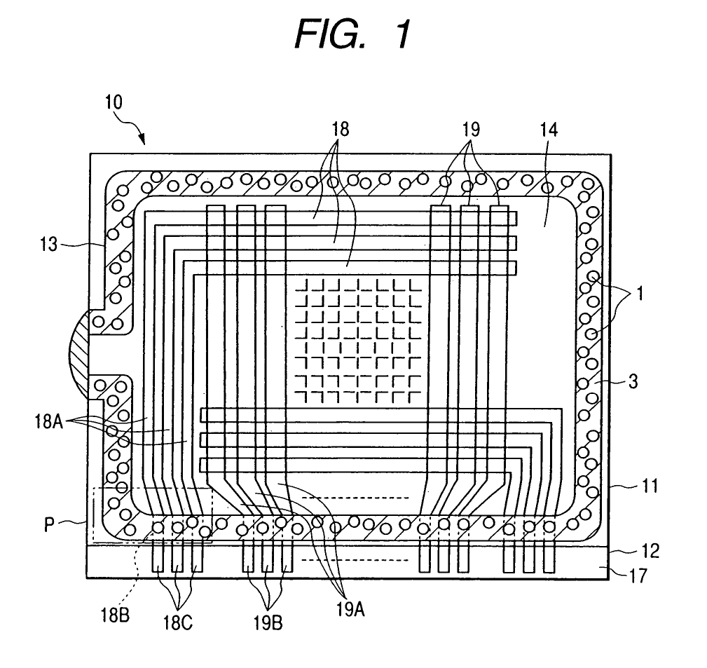

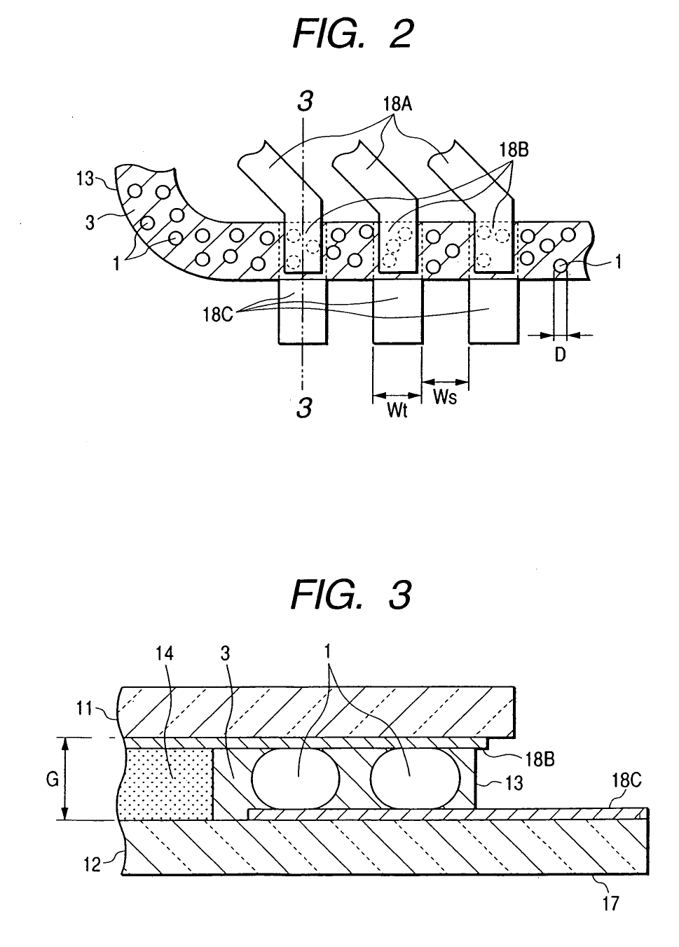

FIG. 1 is a plan view illustrating a liquid crystal display part in this embodiment. FIG. 2 is an enlarged plan view illustrating portion P shown in FIG. 1. FIG. 3 is a cross-sectional view of line 3-3 shown in FIG. 2.

In a liquid crystal display device of the embodiment, wiring lines of the liquid crystal display part are collectively disposed on one of liquid crystal substrates by common transfer. In the liquid crystal display part 10, a liquid crystal layer 14 is formed between two transparent liquid crystal substrate, that is, a common substrate 11 and a segment substrate 12, and a liquid crystal seal 13 having a predetermined thickness G is formed around the liquid crystal layer 14 so that liquid crystals are not leaked and the space between the common substrate 11 and the segment substrate 12, that is, a gap is kept constant. In the segment substrate 12, one side is extended to form a shelf-like terminal part 17.

On the inner surfaces of the common substrate 11 and the segment substrate 12 facing each other, pixel electrodes 18 and 19 for driving the liquid crystals are arranged, respectively, in a matrix. From one ends of the pixel electrodes 18 and 19, wiring lines 18A and 19A are extended and routed inside the liquid crystal seal 13 and around the liquid crystal layer 14 as they are not contacted with each other, being collectively arranged on one side of the liquid crystal seal 13. The wiring lines 18A formed on the common substrate 11 have the ends inserted between the contact surfaces of the common substrate 11 and the liquid crystal seal 13 in parallel to form common terminals 18B. On the other hand, common lead terminals 18C are formed at positions on the segment substrate 12 facing to the common terminals 18B with the liquid crystal seal 13 sandwiched, and the ends thereof are extended to the terminal part 17 of the segment substrate. The ends of the wiring lines 19A formed on the segment substrate 12 pass through the liquid crystal seal 13 and extend to the terminal part 17 of the segment substrate to form segment terminals 19B. The terminal width Wt of each of the common terminals 18B is 20 μm, the terminal interval Ws between the adjacent terminals is 25 μm, and the thickness of the terminal is 0.2 μm.

In the embodiment, the liquid crystal seal 13 is formed of an anisotropic conductive material. In the liquid crystal seal 13, conductive particles 1 are uniformly dispersed in an adhesive resin 3. The mixing ratio of the conductive particles 1 dispersed in the liquid crystal seal 13 is 2.5 percent by weight. The resin 3 is made of epoxy resin, and the conductive particles 1 are made of gold-plated resin. Particle diameter D of the conductive particle 1 is 7 μm, about 1/3.5 of the terminal interval Ws (25 μm) between the common terminals 18B.

As shown in FIG. 3, in the liquid crystal seal 13 interposed between the common terminal 18B and the common lead terminal 18C facing each other, the conductive particles 1 are sandwiched and compressed between the common terminal 18B and the common lead terminal 18C to be deformed flat when fabricated, or the conductive particles 1 press the upper and lower the terminals 18B and 18C and a part of them enter therebetween as described in the Summary of the invention. Consequently, the contact areas of the terminals 18B and 18C with the conductive particles 1 are increased, and conductivity is secured between the upper and lower terminals through the conductive particles 1.

In the meantime, the conductive particles in the terminal interval Ws between the adjacent terminals do not contact any terminals, being electrically isolated in the resin 3. Therefore, the liquid crystal seal 13 in the embodiment realizes anisotropy to conduct only the terminals facing each other. At the same time, the conductive particles 1 in the liquid crystal seal 13 also serve as spacers for defining the gap G between the common substrate 11 and the segment substrate 12. Among the conductive particles 1 in the liquid crystal seal 13, the particles sandwiched between the upper and lower terminals are compressed and deformed flat as described above. However, the terminals do not exist in most of the peripheral part of the liquid crystal seal 13 as shown in FIG. 1. Thus, the particle diameter of the conductive particles 1 dispersed in the portion where the terminals are not formed substantially makes the gap G between the common substrate 11 and the segment substrate 12.

Accordingly, in the liquid crystal display device of the embodiment, a stable gap is secured in the liquid crystal layer 14, and the terminals of all the pixel electrodes are arranged on the surface of the terminal part 17 by common transfer. To the interconnection of the terminals to the terminals of a driver FPC, the configuration of using the anisotropic conductive layer can be applied.

### TEST EXAMPLE 1

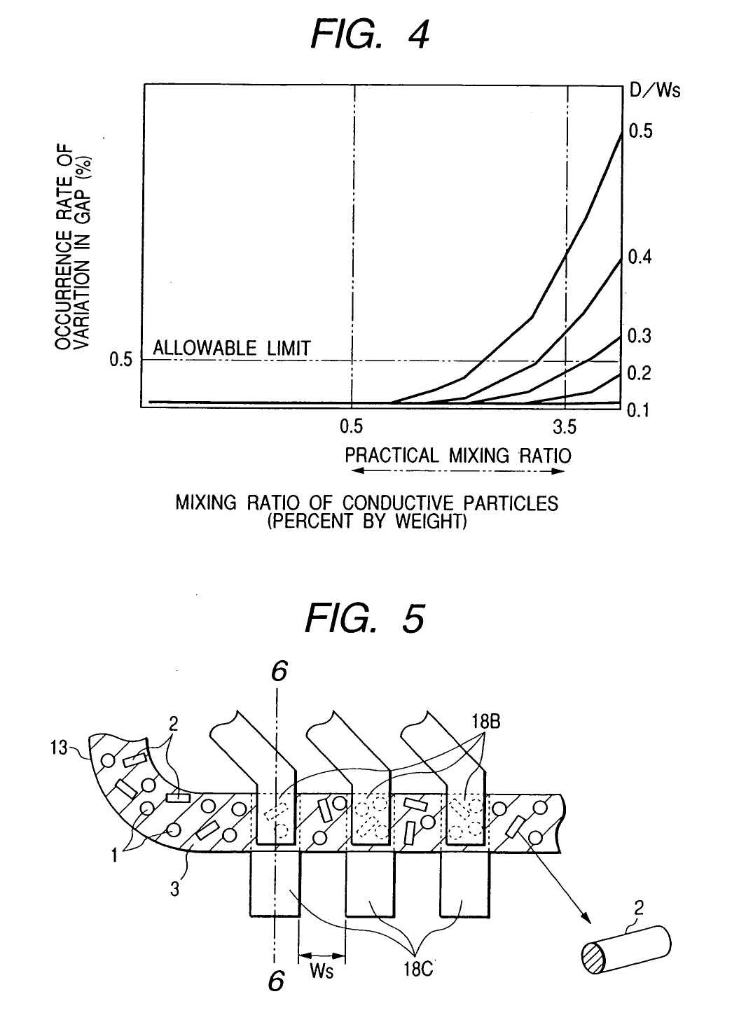

On the liquid crystal seal 13 of the embodiment, the ratio of the particle diameter D of the conductive particle 1 to the terminal interval Ws (D/Ws) and the mixing ratio (percent by weight) of the conductive particles 1 dispersed in the liquid crystal seal 13 were changed variously, and the occurrence rate of variations in the gap was measured in the each case. FIG. 4 shows the result.

As shown in FIG. 4, when the ratio of the particle diameter D to the terminal interval Ws (D/Ws) is 1/3 (0.33) or below, the occurrence rate of variations in the gap can be suppressed within the allowable range, 0.5% or below, at a practical mixing ratio of the conductive particles, that is, within the range that can obtain sufficient conductivity between the upper and lower terminals (0.5 to 3.5 percent by weight).

### Embodiment 2

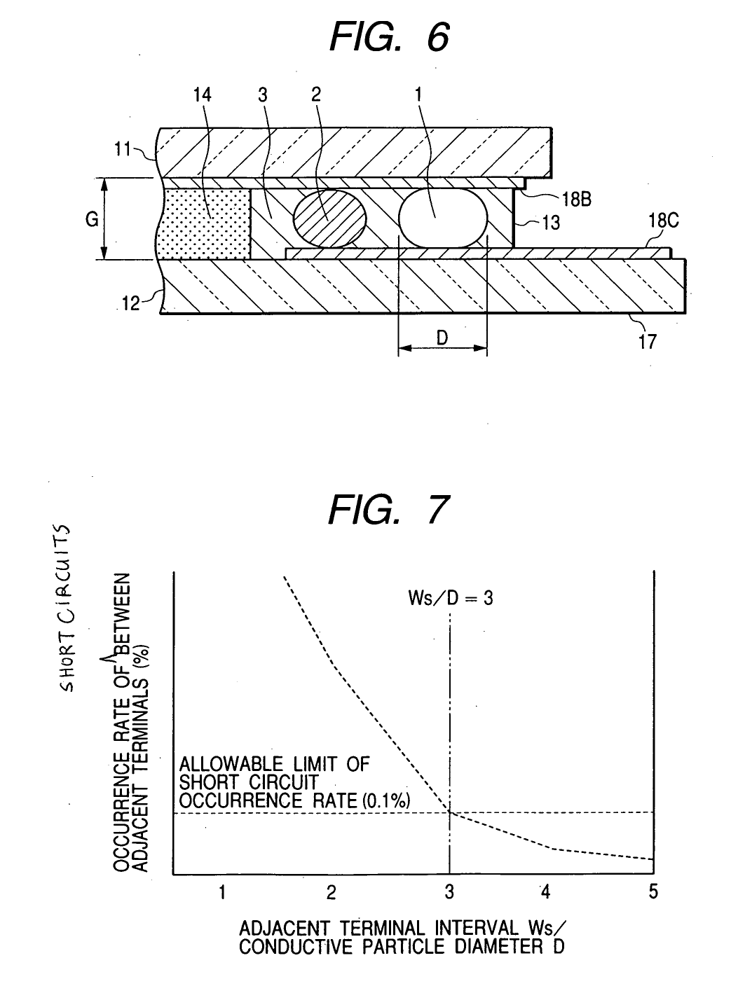

FIG. 5 is a plan view illustrating a liquid crystal display part in this embodiment. FIG. 6 is a cross-sectional view of line 6-6 shown in FIG. 5. The liquid crystal display part of the embodiment is substantially the same as that in the embodiment 1, except that the configuration of a liquid crystal seal 13 is different. Therefore, only the configuration of the liquid crystal seal 13 in the embodiment will be described in detail here.

In the liquid crystal seal 13 of the embodiment, conductive particles 1 and spacers 2 are uniformly dispersed in an adhesive resin 3. The conductive particles 1 are made of gold-plated resin. The mixing ratio of the conductive particles 1 dispersed in the liquid crystal seal 13 is 2.5 percent by weight. The particle diameter D of the conductive particle 1 is 7 μm, about 1/3.5 of the terminal interval Ws (25 μm) between the common terminals 18B.

As shown in FIG. 5 of the enlarged perspective view, the spacers 2 of the embodiment are formed of cuts of glass fiber having the cross-sectional diameter defined, or inorganic beads. The cross-sectional diameter of the spacer 2 defines the gap G of a liquid crystal layer 14 when the liquid crystal seal 13 is formed between a common substrate 11 and a segment substrate 12. In the liquid crystal seal 13 of the embodiment, the particle diameter D of the conductive particle 1 is greater than the cross-sectional diameter of the spacer 2 by 0.35 μm. Therefore, in the portion where the liquid crystal seal 13 is sandwiched between the common terminal 18B and a common lead terminal 18C, the conductive particle 1 is pressed flat by the difference between the particle diameter thereof and the cross-sectional diameter of the spacer 2 to increase the contact areas of the conductive particle with the upper and lower terminals for securing sufficient conductivity. The spacers 2 are formed of hard glass fiber having a small thermal expansion coefficient. Thus, the cross-sectional diameter is not substantially changed even though they are sandwiched and pressed between the common substrate 11 and the segment substrate 12 or by temperature change. Therefore, the gap G of the liquid crystal layer 14 is kept constant. In addition, the thickness of each of the common terminal 18B and the common lead terminal 18C is 0.2 μm, significantly thinner than the gap G of the liquid crystal layer 14. Thus, the difference between the thicknesses of the terminal part and the non-terminal part in the liquid crystal seal can be virtually ignored.

### TEST EXAMPLE 2

On the liquid crystal seal 13 of the embodiment 2, only the terminal interval Ws between the adjacent terminals was changed variously, and the occurrence rate of short circuits between the adjacent terminals was measured, without varying the particle diameter D of the conductive particle, the cross-sectional diameter of the spacer, and the mixing ratio of the conductive particles to the spacers. FIG. 7 shows the result. In FIG. 7, the horizontal axis indicates a scale factor of the terminal interval Ws to the particle diameter D of the conductive particle (Ws/D, that is, the reciprocal of D/Ws). It is apparent from FIG. 7 that the occurrence rate of short circuits between the adjacent terminals can be suppressed within the allowable range of 0.1% or below in the mixing ratio where sufficient conductivity is obtained between the upper and lower terminals when the scale factor of the terminal interval Ws is three times the particle diameter D or greater (that is, D/Ws≦1/3).

With the use of the liquid crystal seal in the embodiment, sufficient conductivity can be secured between the upper and lower terminals in common transfer. In addition to this, the resistance variation, capacitance variation, and short circuits can be effectively suppressed between the adjacent terminals, and a liquid crystal display device having a stable gap of the liquid crystal layer against temperature change can be obtained.

### Embodiment 3

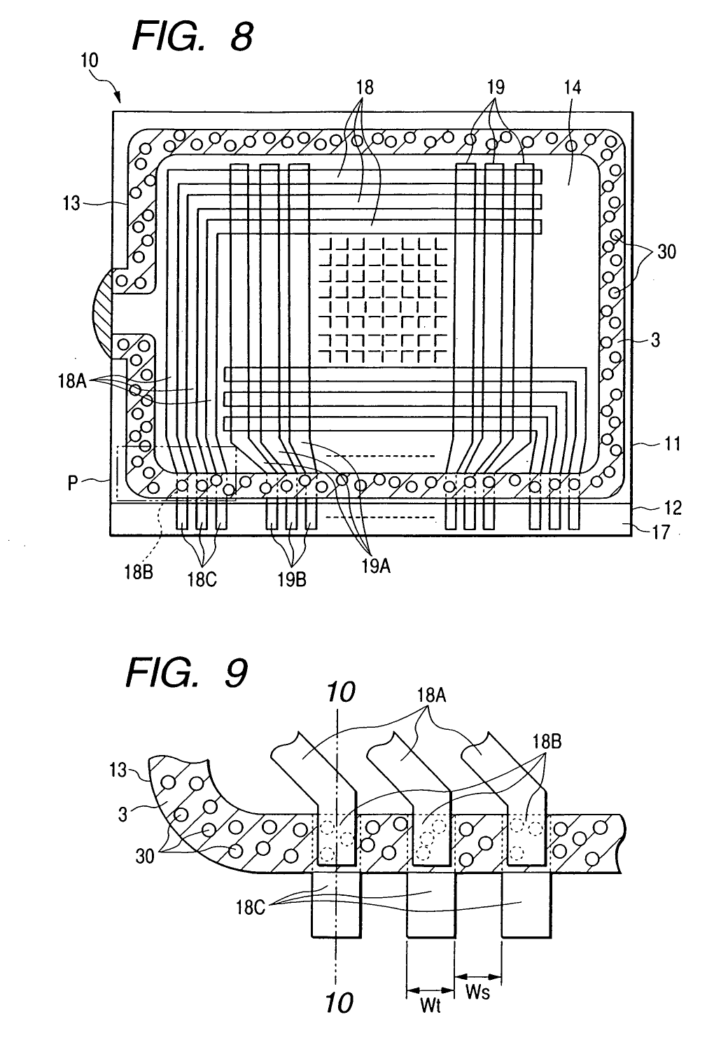

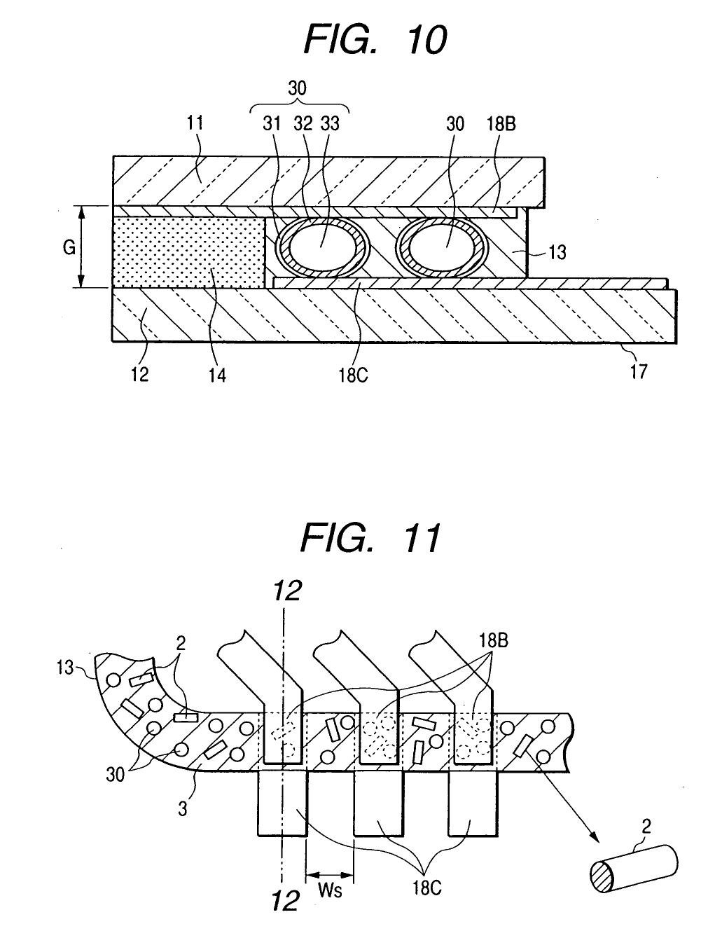

FIG. 8 is a plan view illustrating a liquid crystal display part in this embodiment. FIG. 9 is an enlarged plan view illustrating portion P shown in FIG. 8. FIG. 10 is a cross-sectional view of line 10-10 shown in FIG. 9.

In the liquid crystal display device of the embodiment, the terminal width Wt of a terminal 18B is 25 μm, the terminal interval Ws between the adjacent terminals is 20 μm, and the thickness of the terminal is 0.2 μm. It is substantially the same as that in the embodiment 1, except that the configuration of a liquid crystal seal 13 is different. Therefore, only the configuration of the liquid crystal seal 13 in the embodiment will be described in detail here.

In the embodiment, the liquid crystal seal 13 is formed of an anisotropic conductive material. In the liquid crystal seal 13, conductive particles 30 are uniformly dispersed in an adhesive resin 3. As shown in FIG. 10, the conductive particle 30 is formed of an insulating film 31, a conductive layer 32, and a core material 33. The insulating film 31 is made of an organic silicon compound, the conductive layer 32 is made of a gold thin film, and the core material 33 is made of a divinylbenzene-based resin. The conductive layer 32 is formed on the surface of the spherical core material 33 by electroless plating, and the insulating film 31 is formed on the surface of the conductive layer 32 by a sol-gel process. The particle diameter D of the conductive particle 30 at the surface of the conductive layer is 7.5 μm. The mixing ratio of the conductive particles 30 dispersed in the liquid crystal seal 13 is 3 percent by weight.

As shown in FIG. 10, in the liquid crystal seal 13 interposed between the common terminal 18B and the common lead terminal 18C facing each other, the conductive particles 30 are sandwiched and compressed between the common terminal 18B and the common lead terminal 18C, the portions of the insulating film 31 contacted with the terminals are removed, the exposed conductive layer 32 is directly contacted with the terminals 18B and 18C, and the core material 33 is deformed flat. Consequently, the contact areas of the terminals with the conductive layer 32 are increased, and conductivity between the upper and lower terminals is secured through the conductive particles 30.

On the other hand, the conductive particles 30 in the terminal interval Ws between the adjacent terminals do not contact any terminals, being electrically isolated by the insulating film 31 in the resin 3. Therefore, the liquid crystal seal 13 in the embodiment realizes anisotropy to conduct only the terminals facing each other. At the same time, the conductive particles 30 in the liquid crystal seal 13 also serve as the spacers defining the gap G between a common substrate 11 and a segment substrate 12. As shown in FIG. 8, the conductive particles 30 are dispersed in the entire liquid crystal seal 13, and thus the particle diameter thereof substantially forms the gap G between the common substrate 11 and the segment substrate 12.

Accordingly, in the liquid crystal display device of the embodiment, a stable gap is secured in the liquid crystal layer 14, and the terminals of all the pixel electrodes are collectively arranged on the surface of the terminal part 17 by common transfer. To the interconnection of the terminals to the terminals of a driver FPC, for example, the configuration of using the anisotropic conductive layer described in the embodiment 3 can be applied.

### Embodiment 4

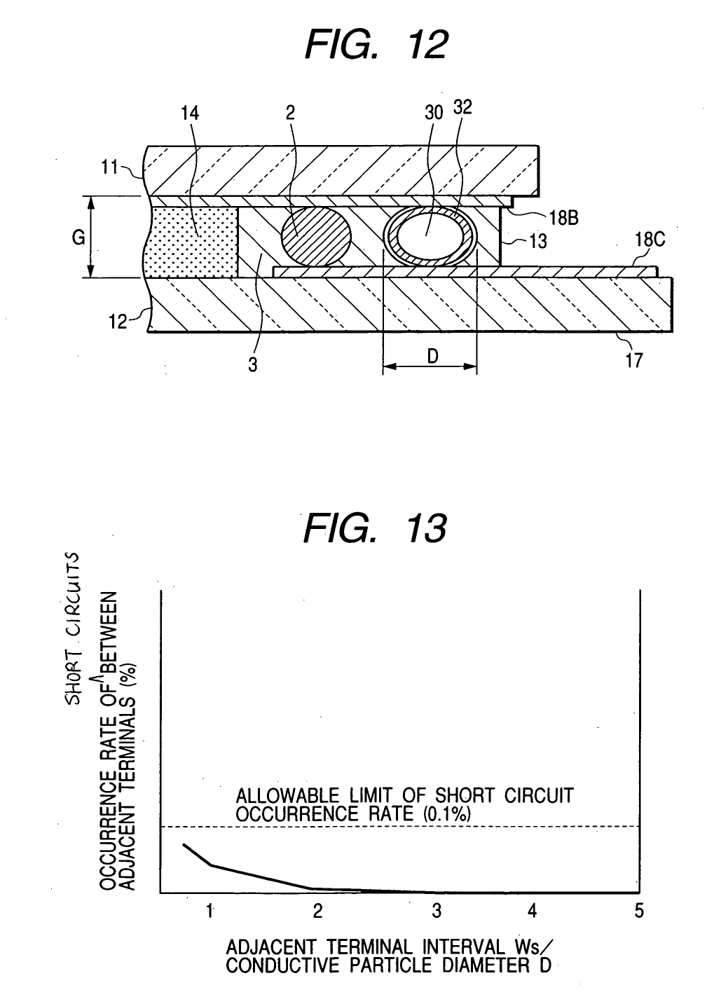

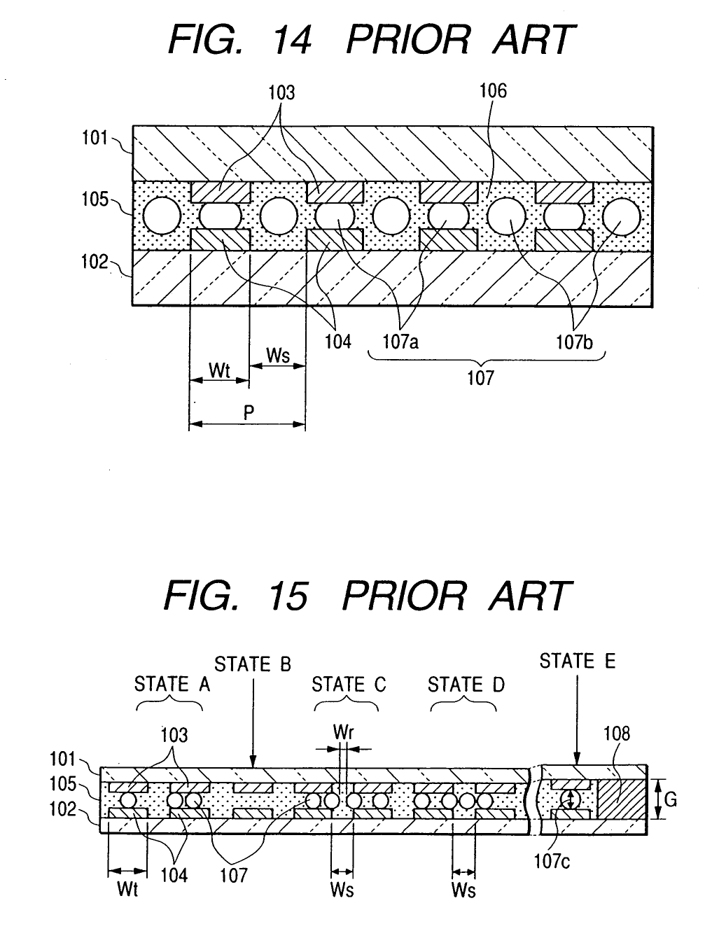

FIG. 11 is a plan view illustrating a liquid crystal display part in this embodiment. FIG. 12 is a cross-sectional view of line 12-12 shown in FIG. 11. The liquid crystal display part of the embodiment is substantially the same as that of the embodiment 3, except that the configuration of a liquid crystal seal 13 is different. Therefore, only the configuration of the liquid crystal seal 13 in the embodiment will be described in detail here.

In the liquid crystal seal 13 of the embodiment, conductive particles 30 and spacers 2 are uniformly dispersed in an adhesive resin 3. Since the configuration of the conductive particles 30 is substantially the same as that used in the embodiment 3, the detailed description will be omitted here. The mixing ratio of the conductive particles 30 dispersed in the liquid crystal seal 13 is 3 percent by weight. The particle diameter D of the conductive particle 30 at the surface of a conductive layer 32 before deformed is 7.5 μm. The terminal interval Ws between terminals 18B is 20 μm.

As shown in FIG. 11 of the enlarged perspective view, the spacers 2 of the embodiment are formed of cuts of glass fiber having the cross-sectional diameter defined, or inorganic beads. The cross-sectional diameter of the spacer 2 defines the gap G of the liquid crystal layer 14 when the liquid crystal seal 13 is formed between a common substrate 11 and a segment substrate 12. In the liquid crystal seal 13 of the embodiment, the particle diameter D of the conductive particle 30 is greater than the cross-sectional diameter of the spacer 2 by 0.35 μm. Therefore, in the portion where the liquid crystal seal 13 is sandwiched between the common terminal 18B and a common lead terminal 18C, the conductive layer 32 of the conductive particle 30 is compressed flat by the difference between the particle diameter thereof and the cross-sectional diameter of the spacer, and an insulating film is removed. Consequently, the contact areas of the conductive particle with the upper and lower terminals are increased, and sufficient conductivity is secured. The spacers 2 are formed of hard glass fiber having a small thermal expansion coefficient. Thus, the cross-sectional diameter is not substantially changed even though they are sandwiched and pressed between the common substrate 11 and the segment substrate 12, or by temperature change. Therefore, the gap G of the liquid crystal layer 14 is kept constant. In addition, the thickness of each of the terminal 18B and the common lead terminal 18C is 0.2 μm, significantly thinner than the gap G of the liquid crystal layer 14. Thus, the difference between the thicknesses of the terminal part and the non-terminal part in the liquid crystal seal can be virtually ignored.

### TEST EXAMPLE

On the liquid crystal seal 13 of the embodiment 4, only the terminal interval Ws between the adjacent terminals was changed variously, and the occurrence rate of short circuits between the adjacent terminals was measured, without varying the particle diameter D of the conductive particle, the cross-sectional diameter of the spacer, and the mixing ratio of the conductive particles to the spacers. FIG. 13 shows the result. In FIG. 13, the horizontal axis indicates a scale factor of the terminal interval Ws to the particle diameter D of the conductive particle (Ws/D).

It is apparent from FIG. 13 that when the anisotropic conductive material having the conductive particles where the conductive layer is covered with the insulating film is used, the ratio of the terminal interval Ws to the particle diameter D (D/Ws) could be reduced greatly to respond the interconnection of high density wiring at a terminal pitch of 10 to 50 μm.

1. A liquid crystal display device comprising groups of terminals connected to each other, the groups of the terminals facing each other through an anisotropic conductive layer having a conductive particle in a resin,
wherein the conductive particle has a conductive layer covered with an insulating film, and
the insulating film is removed in a portion contacted with the terminals to contact the conductive layer with the terminals.

2. The liquid crystal display device according to claim 1, wherein the conductive particle is pressed and deformed in a state that the conductive particle is sandwiched between the terminals.

3. The liquid crystal display device according to claim 1, wherein the insulating film is made of one of a resin and a metal oxide.

4. The liquid crystal display device according to claim 1, wherein the conductive particle has a core material pressable and deformable.

5. The liquid crystal display device according to claim 1, wherein a mixing ratio of the conductive particle in the anisotropic conductive layer is in a range of 0.5 to 3.5 percent by weight.

6. The liquid crystal display device according to claim 1, wherein the anisotropic conductive layer contains a nonconductive spacer, and
a particle diameter of the conductive particle at the conductive layer is greater than a particle diameter of the spacer in a range of 0.02 to 0.5 μm.

7. The liquid crystal display device according to claim 1, wherein one of the groups of the terminals facing each other is formed on a liquid crystal substrate and the other is formed on an external board.

8. The liquid crystal display device according to claim 1, wherein the groups of the terminals facing each other are formed on inner surfaces of liquid crystal substrates facing each other with a liquid crystal layer sandwiched therebetween.
